(19) United States
(12) Patent Application Publication
(10) Pub. No.: US 2009/0255940 A1
(43) Pub. Date: Oct. 15, 2009

(54) Tank

(76) Inventors: Masashi Murate, Aichi-ken (JP); Yoshio Usuki, Aichi-ken (JP); Motohiro Mizuno, Aichi-ken (JP); Natsuhiko Katahira, Aichi-ken (JP)

Correspondence Address: KENYON & KENYON LLP, 1500 K STREET N.W., SUITE 700, WASHINGTON, DC, 20005, US

(21) Appl. No.: 11/992,957

(22) PCT Filed: Nov. 7, 2006
(86) PCT No.: PCT/JP2006/322517

§ 371 Date: Apr. 2, 2008

(30) Foreign Application Priority Data
Nov. 8, 2005 (JP) 2005-323052
Mar. 7, 2006 (JP) 2006-060484

(51) Int. Cl. F17C 1/08; F16J 12/00

(52) U.S. Cl. 220/592; 220/661

(57) ABSTRACT

An opening section of a tank projects to the inside of the tank. In the inwardly projecting section, a fitting projects to the inside of the tank, surrounding a substantially cylindrical column-like valve. Also, an inner circumferential wall projects to the inside of the tank so as to surround the fitting. Further, a metal ring is provided surrounding the inner circumferential wall, and a metal nut is attached from the end in the direction of the projection of the inner circumferential wall. The metal ring and the metal nut function as support members for supporting the inner circumferential wall and increase the quality of the seal between the inner circumferential wall and the fitting.

### TECHNICAL FIELD

The present invention relates to a tank, and, more particularly, to a sealing structure of a tank.

### BACKGROUND ART

Tanks, for example, those storing a fuel gas (a fuel stored in a gaseous state) or the like for use in a vehicle, are in conventional use. Typically, such tanks have an opening formed on a part of their circumferential wall, and a valve is inserted into the opening to ensure that the fuel gas or the like remains sealed in the interior of the tank. Various techniques related to a sealing structure of the tank, in particular, a structure for sealing an opening section have been suggested.

For example, a structure in which an opening section of a tank is protruded toward an inner region of the tank is proposed in Japanese Patent Publication JP 2003-247696 (Patent Document 1). Because the opening section protrudes into the inner region of the tank, it can be expected that the pressure of a fuel gas or the like filled in the tank produces an effect of fastening the opening section. On the other hand, a structure in which an opening section of a tank is protruded toward the outside of the tank has also been known.

### DISCLOSURE OF THE INVENTION

An opening section of a tank is projected into an inner region of the tank to thereby provide a tank with superior sealing performance. Against the background of the conventional technologies, the inventors of the present application engaged in rigorous study and development of structures to further improve the sealing performance, enable easy manufacturing, or provide other advantages.

The present invention, which was conceived against the above-described background, provides improved technology related to a sealing structure of a tank.

In order to realize the improved technology, a tank according to a preferred embodiment of the present invention is provided with an opening formed on a circumferential wall and comprises a circumferential wall member that forms the circumferential wall and a support member that supports the circumferential wall member. In the tank, the circumferential wall member has an inwardly projecting section which projects into an inner region of the tank in an opening section so as to surround the opening, and the support member supports the inwardly projecting section of the circumferential wall member from outside the opening in a radial direction.

In the above-described structure, for example, the support member can prevent the inwardly projecting section of the circumferential wall member from extending outward along the radial direction of the opening. In this case, it is desirable that the support member is a component having a hardness which is greater than that of the circumferential wall member. As a result, it becomes possible, for example, to prevent the inwardly projecting section from expanding outward along the radial direction of the opening.

On the other hand, when it is assumed, for example, that the inwardly projecting section of the circumferential wall member is composed of a resin liner and that the inwardly projecting section is brought into contact with a fitting formed of, for example, a metal via an O ring or other components, it is conceivable that, because a coefficient of thermal expansion of the metal differs from that of the resin, a gap will be created between the inwardly projecting section formed of resin and the fitting formed of metal as the temperature changes, which may have a detrimental effect on the sealing performance.

As opposed to the structure assumed above, because the inwardly projecting section formed of resin is supported, for example, by the support member formed of metal in the structure of the present application, creation of a gap between the inwardly projecting section and the fitting due to changes in temperature can be prevented. In addition, an increase of an aperture area (i.e. the widening of the diameter) in the opening section of the tank can be suppressed when the opening section is supported from outside by the support member.

Here, the support member is not necessarily composed of metal, and may be, for example, made of a hard resin. Preferably, the support member is composed of a material harder than the inwardly projecting section (such as, for example, the resin liner) of the circumferential wall member, in other words, a material which is less deformed by external forces.

In one configuration, the support member comprises a nut for tightening the inwardly projecting section of the circumferential wall member from an end part in a projecting direction of the inwardly projecting section. In another configuration, the support member comprises a ring that surrounds the inwardly projecting section of the circumferential wall member from outside the opening in the radial direction.

In still another configuration, the support member is a component having a hardness which is higher than that of the circumferential wall member. In another configuration, the inwardly projecting section of the circumferential wall member is formed of resin, and at least one of the nut and the ring included in the support member is formed of metal.

In another configuration, a fitting for supporting the inwardly projecting section of the circumferential wall member from inside the opening in the radial direction is further provided, and the inwardly projecting section of the circumferential wall member is held between the ring in the support member and the fitting. In another configuration, a sealing material is provided between the inwardly projecting section of the circumferential wall member and the fitting.

In a further configuration, the ring in the support member has a tapered shape in which a diameter of the ring is decreased toward an inner region of the tank along the projecting direction of the inwardly projecting section.

Still further, in order to realize the provision of the improved technology, the tank according to one configuration of the present invention has an opening formed on the circumferential wall, and comprises the circumferential wall member that forms the circumferential wall and the support member that supports the circumferential wall member. In the tank, the circumferential wall member has an inwardly projecting section which projects into the inner region of the tank in the opening section so as to surround the opening, and the support member supports the inwardly projecting section of the circumferential wall member from outside the opening in the radial direction. In addition, the tank further comprises the fitting for supporting the inwardly projecting section of the circumferential wall member from inside the opening in the radial direction, and a contact domain (contact region) where the support member is brought into contact with the fitting is established. Then, the support member and the fitting are kept in tight contact with each other on the contact domain to thereby prevent the support member from moving toward the inner region of the tank.

In the above-described structure, for example, when the circumferential wall member is extended due to heat treatment or other processing applied in the process of forming the tank, thereby exerting a force that tries to shift the support member, the shifting of the support member toward the inner region of the tank can be prevented because the support member and the fitting are kept in tight contact with each other. As a result, for example, creation of the gap on the surface where the circumferential wall member contact with the fitting or the like can be prevented.

In another configuration, the support member has a protruding surface which is formed along a circumference surrounding the opening so as to protrude toward an inner region of the opening in the radial direction, and the fitting has a side face section which corresponds to the protruding surface of the support member and has an outer diameter dimension greater than an inner diameter dimension of the protruding surface of the support member. Further, the fitting is inserted into the support member to bring the protruding surface of the support member into contact with the side face section of the fitting, thereby causing the protruding surface and the side face section to function as the contact domain in which the side face section of the fitting is fastened by the protruding surface of the support member to keep the support member and the fitting in tight contact with each other.

In a configuration, the fitting is formed of a material having a coefficient of linear expansion greater than that of the support member. Accordingly, expansion of the fitting which is greater than that of the support member is caused by application of heat to bring the support member into tight contact with the fitting on the contact domain.

According to the present invention, a tank with an improved sealing structure is provided. As a result, for example, broadening of the inwardly projecting section outward in the radial direction of the opening can be prevented. Further, because the inwardly projecting section formed of resin is supported by the support member formed of metal, creation of gaps between the inwardly projecting section and the fitting due to changes in temperature can also be prevented.

### BRIEF DESCRIPTION OF THE DRAWINGS

FIG. 1 is a cross-sectional view showing a main part of a tank according to the present invention.

FIG. 2 is an enlarged cross-sectional view showing an inwardly projecting section in a tank according to the present invention.

FIG. 3 is an enlarged cross-sectional view showing another inwardly projecting section in a tank according to the present invention.

### BEST MODE FOR CARRYING OUT THE INVENTION

With reference to the drawings, preferred embodiments of the present invention will be described below.

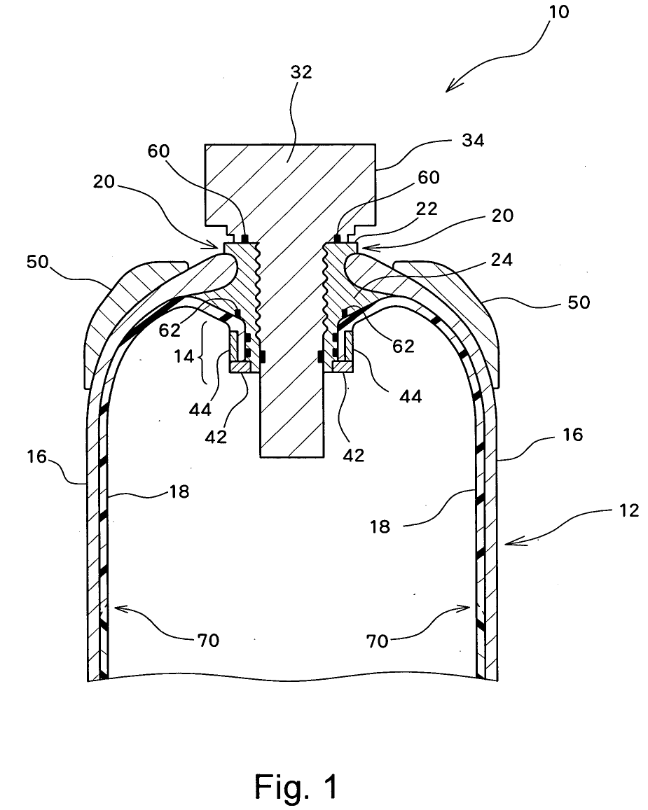

In FIG. 1, a preferred embodiment of a tank. according to the present invention is shown. FIG. 1 is a cross-sectional view depicting a main part of the tank 10.

The tank 10 in this embodiment is used for storing a fuel gas, such as, for example, a hydrogen gas or a natural gas, filled in the inside of the tank 10 (a tank interior), and equipped with a tank main body 12 in the form of a vessel. A circumferential wall of the tank main body 12 is composed of an outer circumferential wall 16 located on an outer side and an inner circumferential wall 18 located an inner side. The outer circumferential wall 16 is, for example, a filament winding of carbon fibers. The inner circumferential wall 18 is, for example, a resin liner which is formed of nylon resin or the like. Alternatively, the inner circumferential wall 18 may be formed of aluminum.

The tank main body 12 has a fitting 20 which is formed of metal in a substantially cylindrical shape. For example, the fitting 20 may be formed of stainless steel or aluminum. It should, however, be noted that the fitting 20 is not limited to a metallic fitting, and may be made of hard resin. On an outer end of the fitting 20, a protruding flange section 22 is formed in an annular shape having a substantially rectangular cross section. In addition, the fitting 20 has a protruding outer circumference section 24 formed on a tank interior region, and the outer circumference section 24 is formed in an annular shape having a substantially triangular cross section. Further, the fitting 20 projects from the outer circumference section 24 into the tank interior.

The fitting 20 is inserted between the outer circumferential wall 16 and the inner circumferential wall 18, which causes a region from the flange section 22 to the outer circumference section 24 in the fitting 20 to function as a part of the circumferential wall. The circumferential wall 16 is held between the flange section 22 and the outer circumference section 24 of the fitting, while the outer circumference section 24 of the fitting 20 is held between the outer circumferential wall 16 and the inner circumferential wall 18. In addition, the fitting 20 projects into the tank interior along the inner circumferential wall 18.

The fitting 20 has, in the inside thereof, an opening formed in a shape of a substantially cylindrical column so as to function as an opening of the tank main body 12. A substantially cylindrical column-like valve 32 is attached to the opening of the fitting 20. A screw is formed on a middle section of the valve 32 along an axial direction, and the opening of the fitting 20 is closed by the valve 32 when the screw of the valve 32 is attached to (screwed into) a thread formed in the opening of the fitting 20.

An outside portion 34 of the valve 32 is formed as a diameter expanded portion which is greater in diameter than other portions of the valve 32, and the diameter expanded portion of the valve 32 is brought into contact with the flange section 22 of the fitting 20. Further, an O ring 60 is inserted where the flange section 22 of the fitting 20 contacts with the diameter expanded portion of the valve 32. The O ring 60 may be, for example, a rubber component having superior elasticity and disposed so as to surround a side face of the substantially cylindrical valve 32. Then, the flange section 22 of the fitting 20 contacts the diameter expanded portion of the valve 32 via the O ring 60, to thereby secure sealing performance. Still further, an O ring 62 may be provided also on a surface where the outer circumference section 24 of the fitting 20 contacts with the inner circumferential wall 18, to additionally secure the sealing performance between the outer circumference section 24 of the fitting 20 and the inner circumferential wall 18.

In the tank 10 according to this embodiment, the opening section projects into the inner region of the tank. In an inwardly projecting section 14 of the opening section, the fitting 20 projects into the tank interior so as to surround the substantially cylindrical valve 32. Further, the inner circumferential wall 18 also projects into the tank interior so as to surround the fitting 20. Still further, a metal ring 44 is disposed so as to embrace the inner circumferential wall 18, and a metal nut 42 is attached from an end section of the inner circumferential wall 18 in the projecting direction. The metal ring 44 or the metal nut 42 function as a support member for supporting the inner circumferential wall (resin liner) 18. Moreover, in the inwardly projecting section 14, O rings (shown in FIG. 1 as black areas which are substantially rectangular in cross section) are provided on a connecting surface between the valve 32 and the fitting 20 and on a contact surface between the fitting 20 and the inner circumferential wall 18.

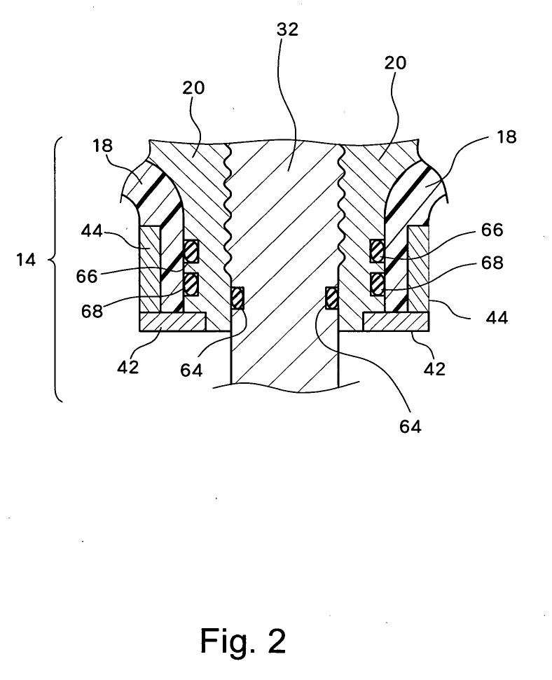

FIG. 2 is an enlarged cross sectional view showing the inwardly projecting section 14. In the inwardly projecting section 14, the valve 32 has a cylindrical shape, and the side face of the valve 32 is surrounded by the fitting 20. The valve 32 has an annular slot which is rectangular in cross-section, and an O ring 64 in the shape of an annular ring is inserted into the slot. The O ring 64 is a component such as, for example, a rubber component having superior elasticity held in the valve 32 by the fitting 20 in a state where the O ring 64 is elastically deformed, thereby sealing an interface between the valve 32 and the fitting 20. As a result, leakage of the fuel gas or the like contained in the tank interior from the interface between the valve 32 and the fitting 20 can be prevented.

In the inwardly projecting section 14, the fitting 20 also has a cylindrical shape in which an opening in the shape of a cylindrical column is formed along an axis of the center of the fitting 20, and the valve 32 is inserted into the opening. Then, a side face of the fitting 20 is surrounded by the inner circumferential wall 18. Further, the fitting 20 has annular slots which are rectangular in cross section, and two annular O rings 66 and 68 are respectively inserted into the slots. The O rings 66 and 68 are components such as, for example, rubber components having superior elasticity, and are held in the fitting 20 by the inner circumferential wall 18 in the state where the O rings 66 and 68 are elastically deformed, thereby sealing an interface between the fitting 20 and the inner circumferential wall 18. In this manner, leakage of fuel gas or other contents of the tank interior from the interface between the fitting 20 and the inner circumferential wall 18 can be suppressed or prevented.

Further, in the inwardly projecting section 14, the metal ring 44 is disposed so as to surround the inner circumferential wall 18. Then, the metal nut 42 in the shape of an annular ring is attached from the end section of the inner circumferential wall 18 located in the tank interior. The metal ring 44 or the metal nut 42 functions as the support member for supporting the inner circumferential wall (resin liner) 18. More specifically, even when elastic force of the O rings 66 and 68, for example, acts to extend the inner circumferential wall (resin liner) 18 to the outside of the opening in the radial direction, the metal ring 44 and the metal nut 42 protect the inner circumferential wall (resin liner) 18 from undergoing outward deformation in the radial direction. In consideration of this function, the metal ring 44 and the metal nut 42 are formed of a metal (such as stainless or aluminum) having a hardness higher than that of the inner circumferential wall 18.

On the other hand, during filling or removal of a gas, such as a hydrogen gas, into or from the tank, a significant temperature change commonly occurs at the inwardly projecting section 14 due to endothermic, exothermic, or environmental influences, or other factors. Further, the coefficients of thermal expansion of metals significantly differs from those of resins. Accordingly, in a state where the metal ring 44 and the metal nut 42 are not attached, there is a possibility that a gap will be created between the inner circumferential wall (resin liner) 18 and the fitting 20 as the temperature changes. However, because in this embodiment the inner circumferential wall (resin liner) 18 is supported by the metal ring 44 and the metal nut 42 from outside the opening in the radial direction, no gap will be created between the inner circumferential wall (resin liner) 18 and the fitting 20, even during changes in temperature.

As described above, in this embodiment the sealing performance for sealing the interface between the inner circumferential wall 18 and the fitting 20 is significantly enhanced by both the metal ring 44 and the metal nut 42. It should be noted that although the support member may be embedded in the inner circumferential wall 18, a configuration in which the support member is externally provided to (disposed radially outside) the inner circumferential wall 18 as shown in FIG. 2 is more preferable in terms of ease of manufacture. In such a configuration, because the support member may be simply attached to the outside of the inner circumferential wall 18, assembly becomes simple, and the manufacturing process can be simplified. Moreover, a backup ring may be provided in the inner region of the inner circumferential wall 18 in addition to provision of the metal ring 44 outside the inner circumferential wall 18.

Still further, the metal ring 44 may be formed in a tapered shape in which the diameter of the metal ring 44 decreases along the projecting direction of the inner circumferential wall 18, i.e. decreases toward the inner region of the tank. In this case, it is desirable that the inner circumferential wall 18, the fitting 20, the valve 32, the metal nut 42, and other components in the inwardly projecting section 14 are formed in the shape corresponding to the tapered shape of the metal ring 14.

Next, again referring again to FIG. 1, a method for manufacturing the tank 10 according to this embodiment will be described.

First, the inner circumferential wall (resin liner) 18 in which the metal ring 44 is inserted in the inwardly projecting section 14 is produced. Here, the inner circumferential wall 18 is divided at a joint section 70, indicated by a broken line in FIG. 1, into two pieces consisting of upper and lower parts in a vertical direction of FIG. 1. It should be noted that the bottom of the lower part is not illustrated in FIG. 1. The dividedly formed upper and lower parts of the inner circumferential wall 18 are connected to each other later.

The upper part of the inner circumferential wall 18 illustrated in FIG. 1 is closely attached via the O ring to the fitting 20. Then, the metal nut 42 in the shape of the annular ring is inserted from the end section of the inner circumferential wall 18 located in the tank interior, to thereby securely seal the interface between the fitting 20 and the inner circumferential wall 18.

The lower part of the inner circumferential wall 18, which is omitted from the drawing, is configured in a way similar to that used for forming the upper part, and the upper and lower parts of the inner circumferential wall 18 are welded at the joint section 70 to each other by means of a heating apparatus such as a laser. Then, carbon fibers in which resin (for example, epoxy resin) is impregnated are filament wound around an outer surface of the welded one body of the inner circumferential wall 18 to cover the inner circumferential wall 18, which is then dried to form the tank main body 12 having a two-layer structure composed of the inner circumferential wall 18 and the outer circumferential wall 16.

Further, the valve 32 is inserted through the O ring into the fitting 20 in the formed tank main body 12. It should be noted that a pressure reducing regulator or a regulator valve having both a valve function and a pressure reducing function may be inserted in place of the valve 32. In addition, a protective pad 50 formed of urethane for protecting corners of the tank main body 12 may be attached to the tank main body 12. In this manner, the tank 10 according to this embodiment is complete.

Next, another preferred embodiment (an example modification) of the present invention will be described.

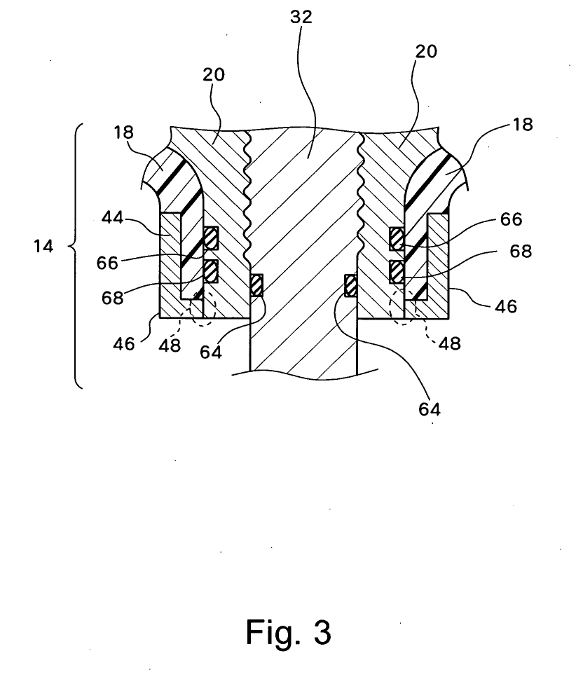

FIG. 3 is an enlarged cross-sectional view showing the inwardly projecting section 14 in this modified example. When a tank as shown in FIG. 3 is compared with the tank shown in FIGS. 1 and 2, it is noted that there is a difference in the support members for supporting the inner circumferential wall (resin liner) 18 in the inwardly projecting section 14.

More specifically, the metal ring 44 and the metal nut 42 function as the support member in the configuration shown in FIGS. 1 and 2, while in the modified example shown in FIG. 3 an insert ring 46 formed in a shape matching an integral shape of the metal ring 44 and the metal nut 42 functions as the support member.

Components other than the support member in the example of modification shown in FIG. 3 are identical to those of the embodiment shown in FIGS. 1 and 2. Namely, in the example of modification of FIG. 3, the valve 32 has a cylindrical shape in the inwardly projecting section 14, and the side surface of the valve 32 is surrounded by the fitting 20. The valve 32 has an annular slot which is rectangular in cross section, and an annular O ring 64 is inserted into the slot. The O ring 64, which is made of a material such as, for example, rubber having a preferable elasticity, is retained in the valve 32 by the fitting 20 in the state where the O ring 64 is elastically deformed, thereby sealing an interface between the valve 32 and the fitting 20. As a result, leakage of fuel gas or other contents of the tank from the interface between the valve 32 and the fitting 20 can be prevented.

Further, in the inwardly projecting section 14, the fitting 20 also has a cylindrical shape in which an opening is formed in the shape of a cylindrical column along the axis of the center of the fitting 20, and the valve 32 is inserted into the opening. Then, the side surface of the fitting 20 is surrounded by the inner circumferential wall 18. In addition, the fitting 20 has annular slots which are rectangular in cross section, and two O rings 66 and 68 are inserted into the annular slots. The O rings 66 and 68 are made of a material, such as, for example, rubber having a preferable elasticity, and are retained in the fitting 20 by the inner circumferential wall 18 in the state where the O rings 66 and 68 are elastically deformed, thereby sealing the interface between the fitting 20 and the inner circumferential wall 18. In this way, leakage of the fuel gas or other contents of the tank from the interface between the fitting 20 and the inner circumferential wall 18 can be prevented.

Then, in the modified example shown in FIG. 3, the insert ring 46 formed of metal is disposed so as to surround the inner circumferential wall 18 in the inwardly projecting section 14. The insert ring 46 functions as the support member for supporting the inner circumferential wall (resin liner) 18. In other words, for example, when elastic force of the O rings 66 and 68 acts to extend the inner circumferential wall (resin liner) 18 to the outside of the opening along the radial direction, the insert ring 46 formed of metal prevents the inner circumferential wall 18 from undergoing outward deformation in the radial direction.

Further, in the modified example shown in FIG. 3, the insert ring 46 is brought into contact with the fitting 20 at a contact surface 48. The contact surface 48 is a surface where an inner circumference face of the insert ring 46 in a portion that projects into the inner region along the radial direction is contacted with an outer circumference face of the fitting 20 having the cylindrical shape. Then, in the example of modification shown in FIG. 3, the insert ring 46 and the fitting 20 are kept in tight contact at the contact surface 48.

In order to realize the capability of tight contact, the fitting 20 is formed in such a manner that the outer diameter dimension of the fitting 20 becomes greater than the inner diameter dimension of the insert ring 46 in the contact surface 48. Thus, after forming the inner circumferential wall 18 in which the insert ring 46 is inserted, the fitting 20 having the greater outer diameter dimension is press-fitted into the insert ring 46. Then, when the fitting 20 is press-fitted, the insert ring 46 extends outward in the radial direction on the contact surface 48, thereby forming a structural relationship as shown in FIG. 3. In this manner, the force with which the insert ring 46 tightens the fitting 20 towards the inner region in the radial direction is created on the contact surface 48, and the insert ring 46 is brought into tight contact with the fitting 20 by that force.

Here, the above-described capability of tight contact using the difference in diameter dimension between the outer diameter dimension of the fitting 20 and the inner diameter dimension of the insert ring 46 in the contact surface 48 may be used in combination with a capability of tight contact provided by a difference in linear expansion, which will be described below, between the fitting 20 and the insert ring 46. In such a combined use of the capabilities, because the difference between the diameter dimensions of the fitting 20 and the insert ring 46 in the contact surface 48 can be reduced, the fitting 20 may be configured so as to more easily be inserted into the insert ring 46, thereby reducing a press-fitting load required for insertion.

As described above, the fitting 20 and the insert ring 46 are mated by means of interference fit in the example of modification shown in FIG. 3. Further, because the insert ring 46 and the fitting 20 are kept in tight contact with each other on the contact surface 48, the insert ring 46 is prevented from moving towards the inner region of the tank. Although in this example, both the fitting 20 and the insert ring 46 are formed of an aluminum material, for example, in order to realize the above-described capability of tight contact, alternatively, both of the fitting 20 and the insert ring 46 may be formed of a stainless steel material or the like.

The tank according to the present invention has the above-described two-layer structure consisting of the inner circumferential wall 18 and the outer circumferential wall (indicated by reference numeral 16 in FIG. 1) which is formed by filament winding, on the outer surface of the inner circumferential wall 18, carbon fibers impregnated with resin (such as, for example, epoxy resin) to coat the inner circumferential wall 18 with the carbon fibers. After the formation of the filament wound carbon fibers, heat hardening or other processing is performed. During the heat hardening processing, the inner circumferential wall 18 which is the resin liner is expanded, and the expansion of the inner circumferential wall 18 might create, in some cases, a force which tries to shift the insert ring 46 toward the inner region of the tank.

When the insert ring 46 is allowed to freely slide relative to the fitting 20, the insert ring 46 can be shifted to the inner region of the tank due to the expansion of the inner circumferential wall 18 associated with the heat hardening processing, but it is possible that a gap is formed between the fitting 20 and the inner circumferential wall 18 or between the outer circumferential wall (indicated by reference numeral 16 in FIG. 1) and the inner circumferential wall 18.

In contrast to this, because the insert ring 46 is kept in tight contact with the fitting 20 on the contact surface 48 in the example modification shown in FIG. 3, the shifting of the insert ring 46 toward the inner region of the tank can be prevented. Accordingly, the possibility of a gap forming between the fitting 20 and the inner circumferential wall 18 or between the outer circumferential wall and the inner circumferential wall 18 can be eliminated.

Further, the difference in linear expansion between the fitting 20 and the insert ring 46 may be used to realize the tight contact capability. More specifically, the fitting 20 may be formed of a material having a coefficient of linear expansion which is greater than that of a material forming the insert ring 46 in order that the expansion of the fitting 20 toward the outside in the radial direction caused by heating will be greater than the expansion of the insert ring 46, thereby realizing tight contact between the insert ring 46 the fitting 20 on the contact surface 48. As an example combination of materials to realize the difference in liner expansion, the fitting 20 may be formed, for example of aluminum material, while the insert ring 46 may be formed, of stainless steel.

Further, displacement of the insert ring 46 toward the inner region of the tank may be prevented by forming a protrusion on one of the insert ring 46 or the fitting 20, and forming a hole corresponding to the protrusion in the other of the insert ring 46 or the fitting 20; displacement of the insert ring 46 can then be prevented by fitting the protrusion into the hole.

Each of the above-described tightly-contacting structures associated with the insert ring 46 and the fitting 20 may be used alone, or in combination with one or more of the other structures.

In addition, a hole may be formed on an insert ring 46 side at the contact surface between the insert ring 46 and the inner circumferential wall 18, to realize a structure in which the inner circumferential wall 18 is inserted into the hole. For example, the insert ring 46 in which a plurality of holes extending along the radial direction are previously formed on an inner circumferential side face may be used to form the inner circumferential wall 18 in which that insert ring 46 is inserted. With this configuration, relative rotation of the inner circumferential wall 18 with respect to the insert ring 46 can be prevented, and relative rotation of the inner circumferential wall 18 with respect to the fitting 20 can also be prevented by keeping the insert ring 46 and the fitting 20 in tight contact with each other. Here, an insert ring 46 capable of mating with the fitting 20 may be used.

The preferred embodiments of the present invention have been described above, and a tank according to these embodiments may be filled with, for example, hydrogen used as a fuel gas, and may be installed in a vehicle equipped with a fuel cell. The embodiments disclosed here are provided as illustrative examples only, and should not be regarded as being provided to limit the scope of the present invention.

1. A tank comprising:
an opening formed on a circumferential wall;
a circumferential wall member that forms the circumferential wall; and
a support member that supports the circumferential wall member, wherein
the circumferential wall member has an inwardly projecting section that projects into an inner region of the tank in an opening section so as to surround the opening; and
the support member is disposed on an outside of the circumferential wall member to support the inwardly projecting section of the circumferential wall member from outside the opening in a radial direction.

2. The tank according to claim 1, wherein
the support member comprises a nut for tightening the inwardly projecting section of the circumferential wall member from an end part in a projecting direction of the inwardly projecting section.

3. The tank according to claim 2, wherein
the support member comprises a ring that surrounds the inwardly projecting section of the circumferential wall member from outside the opening in the radial direction.

4. The tank according to claim 3, wherein
the support member is composed of a material having a hardness greater than that of the circumferential wall member.

5. The tank according to claim 4, wherein
the inwardly projecting section of the circumferential wall member is formed of resin, and
at least one of the nut or the ring included in the support member is formed of metal.

6. The tank according to claim 5, further comprising:
a fitting for supporting the inwardly projecting section of the circumferential wall member from inside the opening in the radial direction, wherein
the inwardly projecting section of the circumferential wall member is held between the ring in the support member and the fitting.

7. The tank according to claim 6, wherein
a sealing material is provided between the inwardly projecting section of the circumferential wall member and the fitting.

8. The tank according to claim 7, wherein
the ring in the support member has a tapered shape in which the diameter of the ring decreases towards the inner region of the tank along the projecting direction of the inwardly projecting section.

9. The tank according to claim 1, further comprising:
a fitting for supporting the inwardly projecting section of the circumferential wall member from inside the opening in the radial direction, wherein
a contact region is established where the support member is brought into contact with the fitting, and
the support member and the fitting are kept in tight contact with each other on the contact region to prevent the support member from moving toward the inner region of the tank.

10. The tank according to claim 9, wherein
the support member has a protruding surface which is formed along a circumference surrounding the opening so as to protrude toward an inner region of the opening in the radial direction;
the fitting has a side face section which corresponds to the protruding surface of the support member and has an outer diameter dimension greater than an inner diameter dimension of the protruding surface of the support member; and
the fitting is inserted into the support member to bring the protruding surface of the support member into contact with the side face section of the fitting, thereby causing the protruding surface and the side face section to function as the contact region in which the side face section of the fitting is fastened by the protruding surface of the support member to keep the support member and the fitting in tight contact with each other.

11. The tank according to claim 9, wherein
the fitting is formed of a material having a coefficient of linear expansion greater than that of the support member; and
expansion of the fitting which greater than that of the support member is caused by application of heat to bring the support member into tight contact with the fitting on the contact region.
